(19) United States
(12) Patent Application Publication
(10) Pub. No.: US 2017/0143576 A1
(43) Pub. Date: May 25, 2017

(54) MASSAGING GARMENT

(71) Applicant: MIKE COOKE & COMPANY, Toronto (CA)

(72) Inventors: CARL ERIK KOHN, TORONTO (CA); MARGARET DAUNINE PULTON, VICTORIA (CA); MIKE COOKE, TORONTO (CA); LYNN COOKE, TORONTO (CA)

(21) Appl. No.: 15/358,919

(22) Filed: Nov. 22, 2016

Related U.S. Application Data
(60) Provisional application No. 62/260,033, filed on Nov. 25, 2015.

(51) Int. Cl. A61H 7/00; A41D 27/10; A41D 1/00

(52) U.S. Cl. CPC A61H 7/001; A41D 1/005; A41D 27/10; A61H 2205/06; A61H 2201/5082; A41D 2400/322

(57) ABSTRACT

A massaging garment is provided that may be useful for the treatment of lymphedema or other conditions where massaging a limb is desired. In one embodiment, the massaging garment comprises a sheet of flexible material and a plurality of electrically actuable fibers that are incorporated with the sheet of flexible material. The electrically actuable fibers are spaced apart from each other, and each electrically actuable fiber is actuable to contract when actuated with electricity. The garment also comprises a control module connected to each of the electrically actuable fibers to selectively provide electricity to each electrically actuable fiber to cause each fiber, when selected, to contract. A method of massaging a limb with a garment, and a method of producing a garment are also provided. A method of producing an electrically actuable material is also provided.

This application claims priority to U.S. Provisional Patent Application Ser. No. 62/260,033, filed on Nov. 25, 2015, which is incorporated herein by reference.

### FIELD

The following relates to a garment for providing compression and/or massaging of a limb, and more specifically, a garment having a plurality of electrically actuable fibers.

### BACKGROUND

Interstitial fluid is a solution that bathes and surrounds the cells of humans, and provides the cells of the body with nutrients and a means of waste removal. One of the purposes of the lymphatic system is to return excess interstitial fluid to the blood. Lymph capillaries pick up this excess interstitial fluid and proteins and return them to the blood. After the fluid enters the lymph capillaries, it is called lymph. Lymph nodes are distributed throughout the body along the lymphatic pathways where they filter the lymph before it is returned to the blood.

Lymphedema is a condition that can occur when lymph nodes are compromised or removed (e.g. in the treatment of cancer) and the lymph can no longer be effectively transferred through the lymphatic system. Typically, lymph pools in the affected limb or limbs, which causes tissue swelling. Swelling in a limb increases the limbs susceptibility to infection and loss of functionality.

Treatment for lymphedema often comprises compressing the affected limb to try to prevent the pooling of lymph, combined with massage of the limb to assist in returning any pooled lymph back to the lymphatic system. Manual massaging action on a limb may be regularly required to move lymph fluid up the limb to the nearest working lymph node. For example, an elastic sleeve can be worn on the limb to provide compression. The elastic force of the elastic sleeve compresses the limb to mitigate the pooling of lymph. The elastic sleeve is removed periodically (usually at least a few times each day) and the limb is manually massaged in order to try to push any pooled lymph from the distal end of the limb back towards the proximal end of the limb to a central lymph node that returns the lymph to the blood. This massage is performed either by the individual or preferably by a trained health professional.

Equipment currently available to massage limbs has been in use for many years, but is heavy, cumbersome and is not very portable, so is generally only available in a hospital or clinic environment.

More generally, there are other scenarios where massaging of a limb is desired, e.g., such as treating injuries that cause swelling.

### SUMMARY

Massaging garments and related methods are disclosed herein. According to one embodiment, there is provided a massaging garment comprising a sheet of flexible material. A plurality of electrically actuable fibers is incorporated with the sheet of flexible material. The electrically actuable fibers are spaced apart from each other, and each electrically actuable fiber is actuable to contract when actuated with electricity. A control module is connected to each of the electrically actuable fibers to selectively provide electricity to each electrically actuable fiber to cause each fiber, when selected, to contract.

In some embodiments, the control module comprises an electric pulse generator that generates electrical pulses to actuate the electrically actuable fibers. In some embodiments, the control module is to provide a series of electrical pulses to actuate a particular fiber by: providing one electrical pulse to the particular fiber; determining at least one parameter after the one electrical pulse is provided; and providing another electrical pulse to the particular fiber when the at least one parameter is less than a predetermined threshold. In some embodiments, the at least one parameter is a resistance of the particular fiber, and the predetermined threshold is a predetermined resistance value. In some embodiments, the resistance of the particular fiber is computed by the control module using voltage and current. In some embodiments, the predetermined resistance is a value to avoid compression and/or heating of the fiber beyond a set level.

In some embodiments, the garment further includes a temperature sensor on the garment. The at least one parameter may be a temperature determined by the temperature sensor, and the predetermined threshold may be a predetermined temperature. The predetermined temperature may be to avoid heating of the fiber beyond a set level.

In some embodiments, the garment includes: a first set of wires connecting the control module to a first side of the plurality of electrically actuable fibers, and a second set of wires connecting the control module to a second side of the plurality of electrically actuable fibers. The electrically actuable fibers may comprise a plurality of groups of fibers, each group including a respective set of fibers that are different from the fibers in the other groups. For each group: each fiber in that group connects to a respective different one of the first set of wires, and each fiber in that group connects to a same wire of the second set of wires. In some embodiments, the second set of wires comprises a different wire for each group. In some embodiments, the first set of wires has the same number of wires as fibers in each group. In some embodiments, the first set of wires includes a larger number of wires than number of fibers in each group, and a fiber in one group is connected to a wire in the first set of wires that is different from wires in the first set of wires that connect to fibers in an adjacent group.

In some embodiments, the garment includes: a first subset of electrical connections and a second subset of electrical connections, wherein: each fiber is connected to a respective combination of one connection of the first subset of electrical connections and one connection of the second subset of connections, and for each fiber, the control module is to activate said respective combination of one connection of the first subset of electrical connections and one connection of the second subset of electrical connections to actuate the fiber. In some embodiments, each of the fibers has a first end and a second end opposite to the first end. In some embodiments, the first subset of electrical connections is connected to the fibers at said first ends, and the second subset of electrical connections is connected to the fibers at said second ends. In some embodiments, the fibers comprise a plurality of groups of fibers, wherein each connection of the first subset of electrical connections is connected to a respective one fiber of the fibers of each group, and each connection of the second subset of electrical connections is connected to all of the fibers of a respective group.

In some embodiments, the sheet of flexible material is heat resistant.

In some embodiments, the control module provides electricity to the fibers of electrically actuable material in a sequential pattern to provide a massaging motion. In some embodiments, the control module is programmable to set the sequential pattern. In some embodiments, the sequential pattern comprises a wave moving along the sleeve.

In another embodiment, there is provided a method of massaging a limb with a garment, the garment comprising a sheet of flexible material and a plurality of electrically actuable fibers incorporated with the flexible material in a spaced apart manner, each electrically actuable fiber being actuable to contract when actuated with electricity. The method may include selectively providing electricity to each electrically actuable fiber to cause each fiber to contract. Selectively providing electricity to each electrically actuable fiber may comprise providing electricity to the fibers in a sequential pattern to provide a massaging motion. In some embodiments, the sequential pattern comprises a compression wave that travels along the limb. In some embodiments, selectively providing electricity to each electrically actuable fiber comprises generating electrical pulses to actuate the electrically actuable fibers.

In another embodiment, there is provided a method comprising: incorporating a plurality of electrically actuable fibers with a sheet of flexible material, each electrically actuable fiber being actuable to contract when actuated with electricity, and electrically connecting a control module to the electrically actuable fibers to selectively provide electricity to each electrically actuable fiber to cause each fiber, when selected, to contract.

In another embodiment, there is provided a method comprising: providing a sheet of flexible material; providing a plurality of electrically actuable fibers, each electrically actuable fiber being actuable to contract when actuated with electricity; incorporating the plurality of electrically actuable fibers with the sheet of flexible material.

Other aspects and features will become apparent to those ordinarily skilled in the art upon review of the following description.

### BRIEF DESCRIPTION OF DRAWINGS

Embodiments will now be described in greater detail with reference to the accompanying diagrams, in which:

FIG. 1 is a side view of a massaging garment according to one embodiment;

FIG. 2 the same side view of the massaging garment of FIG. 1 showing some electrically actuable fibers contracted;

FIG. 3 is a schematic diagram of the garment shown in FIGS. 1 and 2 including a block diagram of a control module;

FIG. 4 is a top view of a garment in an open formation according to another embodiment;

FIG. 5 is a side view of the garment of FIG. 4 in a closed formation;

FIG. 6 illustrates an embodiment of a control module in more detail;

FIG. 7 is an enlarged view of a section of the garment of FIG. 4;

FIG. 8 is a schematic diagram of the garment of FIG. 4;

FIG. 9 is an enlarged view of a section of the garment according to another embodiment;

FIG. 10 is a schematic diagram of the garment according to the embodiment of FIG. 9;

FIG. 11 is a schematic diagram of a garment according to another embodiment;

FIG. 12 and FIG. 13 are top and bottom views, respectively, of a circuit board that may be used to implement the control module shown in FIG. 11;

FIG. 14 is a flowchart of a method for controlling a massaging garment according to one embodiment;

FIG. 15 is a flowchart of another method for controlling a massaging garment according to one embodiment; and

FIG. 16 is a flowchart of a method of producing a massaging garment according to one embodiment.

### DETAILED DESCRIPTION

The embodiments set forth herein represent the necessary information to enable those skilled in the art to practice the claimed subject matter. Upon reading the following description in light of the accompanying figures, those skilled in the art will understand the concepts of the claimed subject matter and will recognize applications of these concepts not particularly addressed herein. It should be understood that these concepts and applications fall within the scope of the disclosure and the accompanying claims.

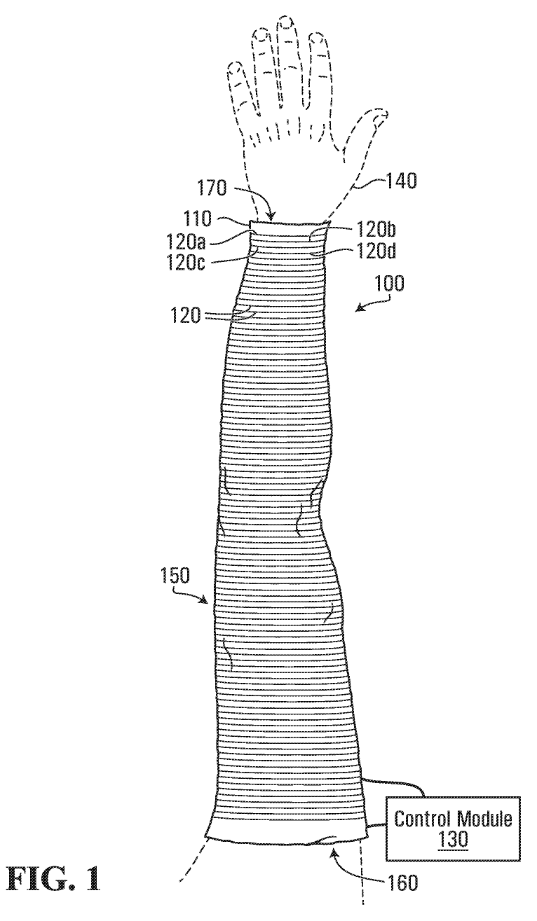

FIG. 1 is a side view of a massaging garment 100 according to one embodiment of the disclosure. The garment 100 includes a sheet of flexible material 110, a plurality of electrically actuable fibers 120, and a control module 130. The fibers 120 are incorporated with the sheet of flexible material 110 in a spaced apart manner. Each electrically actuable fiber 120 is actuable to contract when actuated with electricity. Although the word “fibers” is used herein, they may be implemented in wire form. In this sense, use of the word “fiber” is also meant to encompass wires. In some embodiments, the fibers 120 may be threaded (e.g. woven or sewn) into the sheet 110, or the fibers 120 may be affixed (glued, taped, etc.) to the surface of the sheet 110. The control module 130 is connected to each of the electrically actuable fibers 120 to selectively provide electricity to each electrically actuable fiber 120 to cause each fiber 120, when selected, to contract (or to remain contracted). The contraction of the fibers may provide a compression force to massage the limb 140. Thus the garment 100 may be useful for treatment of lymphedema or other conditions causing similar symptoms. For example, the massaging action may be helpful for treatment of other injuries, such as sports injuries, that result in blood pooling and swelling. However, embodiments are not limited to treatment of lymphedema or other such conditions.

In this embodiment, the sheet of flexible material 110 is in the form of a sleeve 150 for fitting over a limb 140. The limb 140 in this example is an arm. The sleeve has a proximal end 160 and a distal end 170 (relative to a shoulder of a user, which is not shown in FIG. 1). However, other forms and configurations are possible. In other embodiments, a similar garment will fit on other parts of the body, and other embodiments are not limited to sleeve configurations. For example, a similar garment could be configured to fit on a leg, a neck, a shoulder etc. The garment 100 shown in FIG. 1 may also have opened and closed configurations. For example, in an opened configuration (not shown in FIG. 1), the sheet of flexible material 110 could lay substantially flat. The garment 100 could then be wrapped around the limb 140 and closed to form the sleeve configuration.

The flexible sheet 110 may be a heat resistant material such as a heat resistant fabric. For example, Nomex™ cloth may be used as the flexible material 110. In some embodiments, the fibers 120 may become warm or hot when actuated with electricity. Thus, the heat resistant flexible material 110 may prevent damage to the material and/or discomfort or burns to the user. Other materials may be suitable as well for the flexible sheet 110. For example, other embodiments may employ a plastic, or a different fabric.

The electrically actuable fibers 120 include individual fibers 120a, 120b. 120c, 120d etc. Such fibers contract when provided with electricity. The fibers 120 may be BioMetal™ fibers, for example, which are available from Toki Corporation™. When connected to an electrical power source, BioMetal™ fibers heat and contract. Such fibers are conductive and may contract by 4 to 8% when heated above 70 degrees centigrade. Electrically actuable fibers having a diameter of 0.15 mm, for example, may be used. Other electrically sensitive, responsive, or actuable materials may also be suitable.

In FIG. 1, the fibers 120 are shown as visible on the outside of the garment 100 in the sleeve configuration. However, the fibers may be hidden by the flexible material 110 in some embodiments. For example, some embodiments include multiple layers of flexible material, with the fibers sewn into an inner layer.

The fibers 120 in FIG. 1 are arranged substantially parallel to each other and are approximately evenly spaced. The fibers in this example are perpendicular to the lengthwise direction of the sleeve 150. Different embodiments may use different numbers of fibers 120, depending on the desired application. The arrangement and/or spacing of the fibers 120 may also vary. In some embodiments, the fibers are each spaced apart by approximately 1/10 to ⅕ inch, although other spacing distances are possible. The electrically actuable fibers 120 may take different forms and/or be arranged in different patterns in other embodiments. For example, the fibers 120 could form a fan pattern, a grid or another pattern in other embodiments. In other embodiments, rather than thin fibers, an electrically actuable material in other forms such as flattened strips or ribbons of fibers may be used.

As shown in FIG. 1, the fibers 120 form a plurality of approximate rings when the garment is in the form of the sleeve 150, where each ring extends about a longitudinal axis of the limb and around a circumference of the limb when worn. It is to be understood that the fibers 120, when forming approximate ring shapes, do not need to be perfectly aligned or closed rings. For example, each of the fibers 120 may have two opposing ends (not shown) connected to the control module 130. The opposing ends may not be aligned to each other when the garment is fitted or wrapped around the limb 140. Similarly, the fibers 120 may not extend completely around the circumference of the limb 140 or may extend more than the entire circumference.

As mentioned above, the garment 100 may open from the sleeve formation in some embodiments. For example, in some embodiments, the garment 100 may be laid flat, rolled, or folded when not in use. A fastener (not shown) may be used to fasten the garment 100 from an open configuration to the closed sleeve configuration shown in FIG. 1. For example, the fastener may include a zipper, straps. Velcro™ strips, buttons, snaps or any other suitable means for fastening the garment 100. In other embodiments, the garment 100 simply remains in the sleeve 150 configuration and is slid on/off the arm 140. In other embodiments, the sleeve 150 includes an elastic or stretchable portion (not shown) that allows the garment 100 to be fit on a limb.

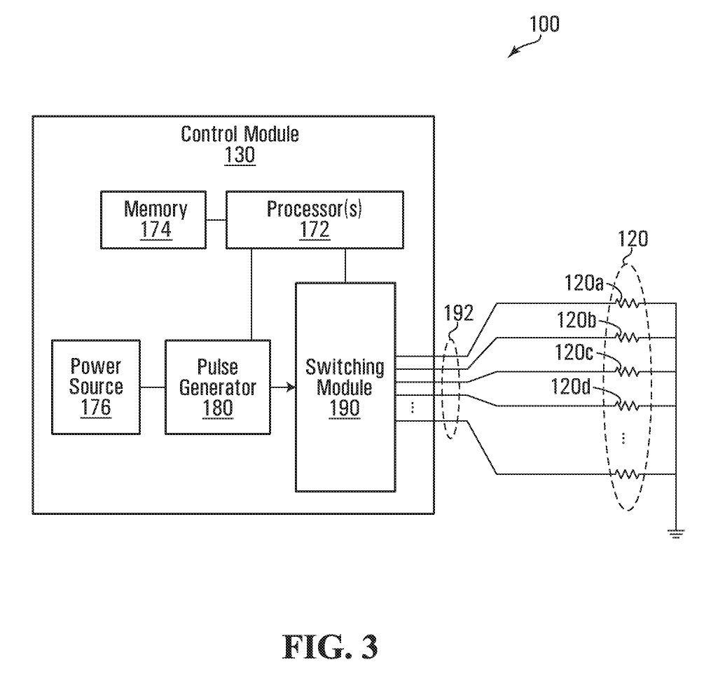

FIG. 3 is a schematic diagram of the garment 100 and the control module 130. The flexible sheet 110 is not illustrated in FIG. 3, and each of the fibers 120 is represented as a resistive element. As shown in FIG. 3, the control module 130 is electrically connected to each of the plurality of fibers 120 (including individual fibers 120a, 120b. 120c, 120d etc.). The control module 130 in this example includes a processor 172 and a memory 174. The processor 172 is illustrated as a single device, but more generally could be more than one device. The control module 130 also includes an internal power source 176. The internal power source 176 may be one or more batteries (not shown). However, other embodiments may use an external power source. For example, the control module 130 may be configured to be connected to a power outlet, or any other suitable power source (external or internal). If configured for connection to an outlet, the garment 100 may include an AC/DC adaptor. The adaptor could provide DC power at 10 to 20 volts, for example.

The control module 130 further includes an electric pulse generator 180 and a switching module 190. The memory 174 is connected to the processor 172, and the processor 172 is connected to the switching module 190 and the pulse generator 180 in this embodiment. The pulse generator 180 receives power from the power source 176 and generates electrical pulses to actuate the fibers 120. As discussed in more detail below, the processor 172 may control how many electrical pulses (i.e. how much power) to provide to each fiber, which may depend upon the state of contraction of the fiber and/or whether the fiber is being actively contracted or whether a current level of contraction is being maintained.

The switching module 190 is electrically connected to the pulse generator 180 and to each of the fibers 120. Specifically, the garment 100 comprises a plurality of electrical connections or links 192 between the electrical control module 130 and the electrically actuable fibers 120. The electrical connections may simply be individual wires between the control module 130 and the fibers 120. Other circuit components (such as diodes, resistors) or even wireless communication components may also be used. The switching module 190 comprises circuitry (e.g. switches) to select one or more of the fibers 120 for actuation and routs the electrical pulses to the selected one or more fibers 120 (via the electrical connections 192). The switching module 190 may selectively activate the electrical connections 192 in order to selectively activate the corresponding fibers 120. For example, the switching module 190 may activate a selected connection 192 that is connected to a selected fiber 120 by closing a switch to create an electrical path between the selected connection 192 and the pulse generator 180, thereby also creating an electrical connection between the corresponding selected fiber 120 and the pulse generator 180. For example, the switching module 190 may be implemented using transistor switches to control the application of power to each fiber 120.

The switching module 190 may be controlled by the processor 172 and/or memory 174. For example, the memory 174 may contain instructions for execution by the processor 172, or for execution by the processor 172 in combination additional hardware not shown. In some embodiments, the pulse generator 180 may also be implemented using the processor 172 and/or the memory 174 (e.g. defined by software), although more generally it may be the case that the pulse generator 180 is instead a separate piece of hardware. The pulse generator 180 and the switching module 190 may include one or more programmable logic components (such as a programmable logic array) that can be used to set a sequence for the fibers 120 to be actuated. For example, a compression wave sequence (as discussed below) may be programmed into to the switching module 190 by a user or a manufacturer. In some embodiments, the sequence is coded into the control module 130 using software and/or hardware such that it cannot be altered. In other embodiments, the sequence is programmable such that it can be altered or set between multiple options by a user.

The operation of the example garment 100 will now be described. With reference to FIG. 1, the control module 130 selectively actuates the fibers 120. To actuate a selected one of the fibers 120, the control module supplies electricity to that selected fiber 120. When activated by electricity, the fibers 120 contract with compression force to massage the limb 140. The control module 130 may actuate the fibers 120 in a sequential pattern such that the garment 100 provides a massaging motion. For example, the sequential pattern may consist of the fibers being actuated in order from the distal end 170 to the proximal end 160 or vice versa. This type of massaging motion may be described as a compression wave that travels along the sleeve 150. The compression wave may be more than one fiber 120 wide. That is, the fibers 120 may be actuated such that two or more adjacent fibers 120 remain contracted as the wave travels along the sleeve 150. As discussed in more detail later, in some embodiments the processor 172 may control the switching module 190 to alternate which fiber in a group of fibers is selected so that pulses of power are alternated between the fibers in the group.

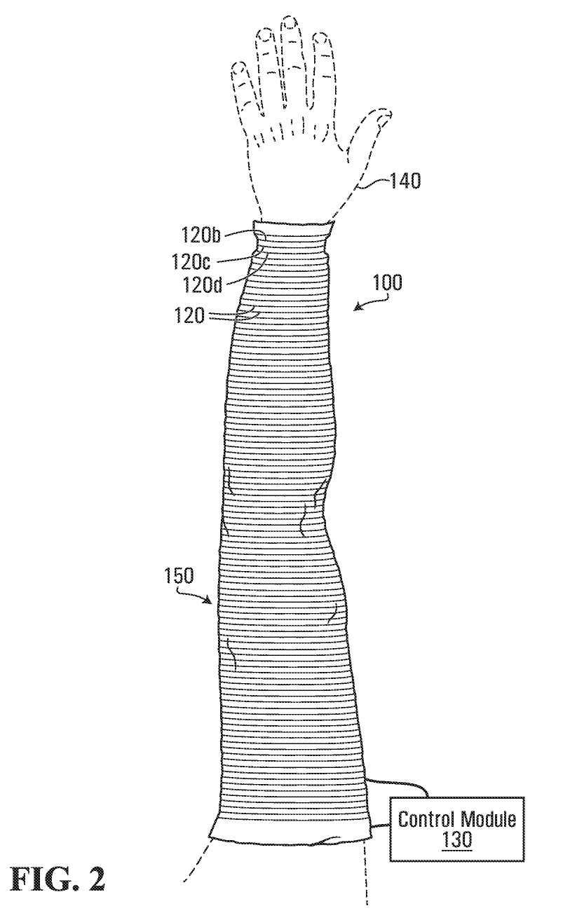

An example compression wave sequence that is three fibers 120 wide will now be described. To start, the control module 130 provides an electric current to the first fiber 120a at the distal end 170 of the sleeve 150, which causes the first fiber 120a to contract. Adequate power is applied to each fiber 120 such that compression is achieved and maintained for an appropriate number of cycles. A cycle has a cycle time, which represents how long a particular fiber is contracted before a new fiber is contracted. The cycle time may be 0.5 to 1 second. For example, assume the cycle time is 1 second and the compression wave is three fibers wide. In the first cycle (t=1), the first fiber 120a is contracted by supplying pulses of power to that fiber. Then, in the next cycle (t=2), power is still provided to the first fiber 120a to maintain the compression of first fiber 120a, while at the same time the control module 130 also provides an electric current to the second fiber 120b adjacent to the first fiber 120a, so that the second fiber 120b contracts. In the third cycle (t=3), power is still provided to the first fiber 120a and the second fiber 120b to maintain the compression, while at the same time the control module 130 provides an electric current to the third fiber 120c, which then contracts for one cycle. The control module 130 then actuates the fourth fiber 120d (to contract the fourth fiber 130d) and stops actuation of the first fiber 120a, so that the first fiber 120a expands to its original length (and no longer provides a compression force). By continuing in this manner, a steady compression area moving up the arm may be applied. In particular, FIG. 2 shows the garment 100 (including control module 130) with the second fiber 120b, the third fiber 120c, and the fourth fiber 120d in the sleeve 150 contracted to compress the limb 140. The control module then continues this sequential pattern so that a compression wave three fibers 120 wide continues up the limb 140 from the distal end 170 of the sleeve 150 to the proximal end 160. The massage action may closely simulate conventional manual massaging action by producing a contraction wave moving at, for example, 0.5 to 2.0 cm per second along the limb 140.

The massaging motion may move up the arm 150 (i.e. generally toward the heart (not shown)) as described above. Such motion may be helpful for injury treatment, be it lymphedema or any injury involving swelling. Nevertheless, the massaging patterns described above are only examples of patterns that may be programmed or set in control module 130. For example, a compression wave may travel in the reverse direction (proximal end 160 to distal end 170). More than one compression wave may travel simultaneously in the same or different directions. The compression wave may be wider (more than three fibers 120) or narrower (less than three fibers 120) wide and/or may change in width depending on the position of the wave in the sleeve 150. The wave may travel at one speed or at variable speeds. These are just some examples of how the massaging pattern may vary.

The electric pulses used to drive or actuate the fibers 120 for the garment 100 may be designed to prevent overheating of the garment 100 or the limb 140. In some embodiments, 25 to 500 pulses of 1 millisecond power may be applied to a single fiber. These specific pulse parameters used may provide sufficient electricity to contract the fiber while keeping the heat produced in the actuated fibers low enough that user discomfort is mitigated or eliminated. In some embodiments, once a fiber 120 is compressed, the amount of power needed to be applied to maintain compression may be lower compared to the amount of power need to be applied to cause the compression in the first place (e.g. 25% of the power may only need to be applied to maintain the compression).

### An Example of Power Control

In one embodiment, the fibers 120 may have the property that when electricity is applied to a fiber, that fiber contracts, but it also heats up. For example. BioMetal™ fibers from Toki Corporation™ have such a property. As mentioned above, a heat resistant fabric may be used as the flexible sheet 110 to help prevent discomfort or burn to the user. However, additional control may be provided by the processor 172 of the control module 130 to try to prevent over-contraction and/or over-heating of the fibers.

Assume BioMetal™ fibers from Toki Corporation™ are used. To contract these specific fibers, the temperature must be raised to a temperature that is typically above about 70 degrees Centigrade. As the fiber has a characteristic resistance of about 0.6 ohms per centimeter, it is possible to heat the fiber by passing a current through it. This current must be controlled or dangerous overheating may occur.

In one embodiment, the power to individual fibers is applied using a sequence of pulses. The amount of power applied to a fiber is controlled by the total length of the ON pulses during a cycle. Each pulse may be about 1 millisecond long. A plurality of pulses is required for the fiber to reach the appropriate temperature for contraction to begin or be maintained. The pulses may be applied all at once to achieve immediate fiber contraction, or spread over time (over the cycle time) to achieve a smoother and more gradual contraction. For example, as discussed earlier the cycle time may be 0.5 to 1 second, and so in one embodiment to try to allow for gradual and uniform contraction the plurality of pulses are spread over about of the cycle time.

In any case, the appropriate number of pulses to apply needs to be determined. Some example ways to determine this are as follows.

Power is applied by connecting the fiber to a voltage source and applying the electrical pulses of current. The pulses may be applied using software Pulse Width Modulation (PWM) technology, or directly programmed pulses. The amount of power applied (i.e. the number of pulses) is controlled to try to achieve adequate contraction while avoiding overheating. Four example ways of doing this are outlined below.

1) Assuming the temperature of the fiber is indicative of its level of contraction, then a temperature sensor (e.g. a thermistor) may be included on the fiber that provides feedback on the temperature. Electrical pulses may be applied until a predetermined temperature is reached. To maintain the contraction, electrical pulses may then continue to be applied as necessary to maintain the temperature at (or around) the predetermined temperature. Note that tests using this implementation suggest that current technology may be too slow to gather and process temperature feedback.

2) Determine the appropriate number of pulses experimentally. The number of pulses required would typically be adjusted for the length of fiber and the voltage applied. Tests using this implementation indicate that about one hundred 1 ms pulses at 12 volts would provide adequate contraction of a 20 cm fiber. Once the appropriate contraction is experimentally determined for each fiber (or each group of fibers), this may be programmed into the control module 130.

3) Monitor both applied voltage and current flowing in milliamps during an electrical pulse. By doing this, the amount of energy imparted to the fiber may be calculated by the control module. In this way, feedback may measure the required amount of power to be applied to a fiber in a unit time. Electrical pulses may be applied until the energy is above a particular threshold, which indicates a particular level of contraction. To maintain the contraction, electrical pulses may then continue to be applied as necessary to maintain the energy above, around, or at the predetermined threshold. Note that, as mentioned above, the power pulses required to maintain a given power (i.e. maintain a given amount of contraction) may be about 20% to 25% of that required to perform the contraction.

4) The resistance of the fiber may correlate to a particular level of contraction (since the resistance changes as the state (amount) of contraction changes). Feedback may then be used to measure the resistance change in the fiber. Assuming the control module 130 knows the length of the fiber, a target resistance may be calculated and determined (e.g. experimentally) to provide the desired contraction. Then, during operation, by measuring the voltage and current applied during a pulse, the control module 130 can compute the resistance of the fiber and then compare it to the target resistance. Adequate contraction is assumed to occur when the measured resistance of the fiber equals the target resistance. Contraction is maintained by maintaining the target resistance. For example, when a fiber is actuated to contract, pulses of power are provided, and after each pulse of power the resistance of the fiber is measured. When the resistance of the fiber is equal to or exceeds the target resistance, then this means that the fiber has adequately contracted, and a further electrical pulse is not provided. Then, once the resistance drops below the target resistance, a further electrical pulse is provided, which continues until the target resistance is again achieved. This process continues to maintain the contraction. Once the fiber is no longer to be contracted, then no further electrical pulses are provided.

More generally, in one embodiment, a method is provided in which the control module 130 is to provide a series of electrical pulses to actuate a particular fiber by: providing one electrical pulse; after the electrical pulse is provided, determining (e.g. measuring) at least one parameter; and providing another electrical pulse when the at least one parameter is less than a predetermined threshold. In one embodiment, the at least one parameter is a temperature of the fiber, and the predetermined threshold is a predetermined temperature (e.g. chosen to result in adequate contraction and/or to avoid heating of the fiber beyond the set temperature). In another embodiment, the at least one parameter is a resistance of the fiber, and the predetermined threshold is a predetermined resistance (e.g. chosen to result in adequate contraction and/or to avoid heating of the fiber beyond a set amount).

Although not explicitly shown in FIG. 3, it will be appreciated that in cases in which feedback is collected and used by the control module 130 to control whether to apply another power pulse, suitable circuitry is present to perform this function. The circuitry may be a processor that executes instructions causing the processor to perform the function, or the circuitry may be dedicated integrated circuitry, such as an FPGA or ASIC.

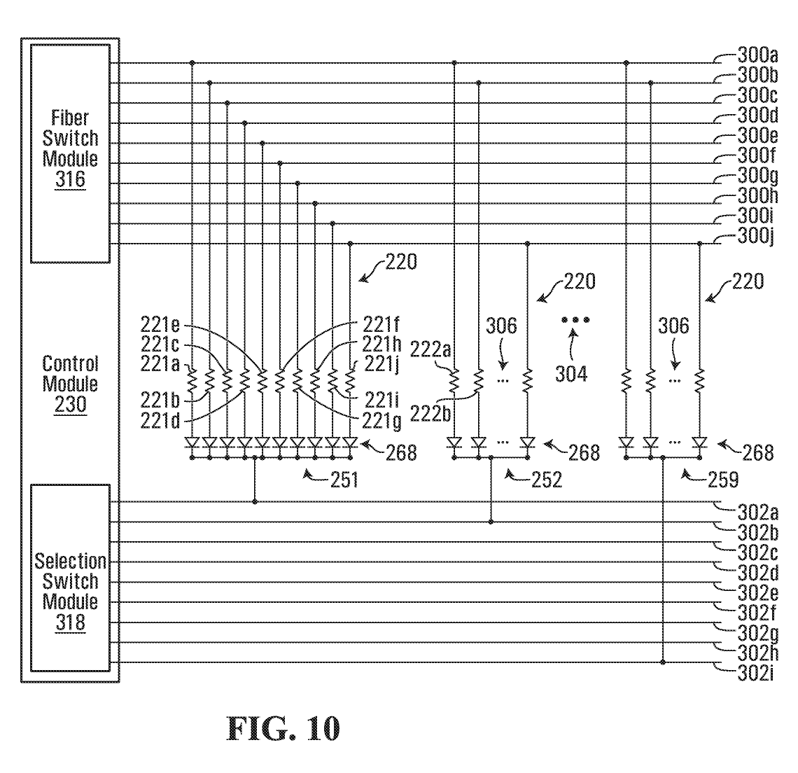

In some embodiments, a plurality of electrical pulses are applied to each of a group of fibers in a round-robin fashion, i.e, in a circular manner, such that each fiber in the group is actuated by an electrical pulse, one at a time, in a particular order, with that order being repeated. For example, if the compression window is three fibers long, and fibers 120b, 120c, and 120d are being actuated, then an electrical pulse may be sent to fiber 120b, then fiber 120c, then fiber 120d, then back to fiber 120b, and so on. A possible benefit of scheduling the power pulses in this manner is that it may simplify the physical electrical connections when creating a moving compression wave several fibers long. It does not matter how big the wave is (i.e. how many fibers wide the wave is), and that can be changed in software. Only one fiber needs to be connected each power pulse. An example of electrical connections for such an embodiment is described later in relation to FIG. 10.

### One Specific Example of a Garment

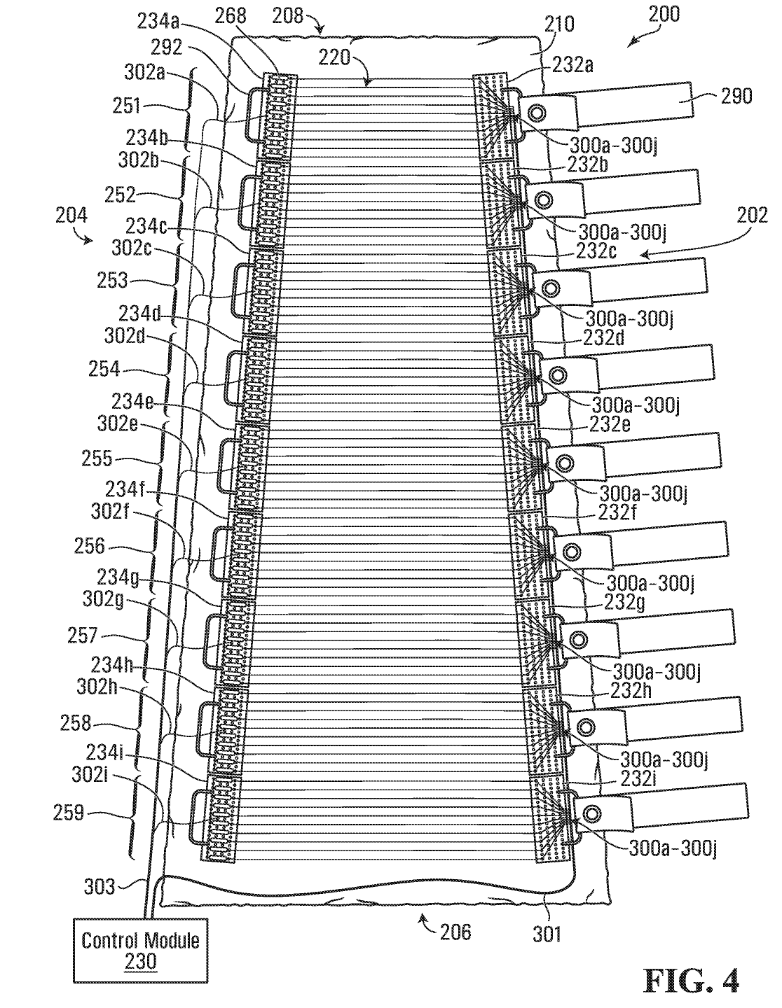

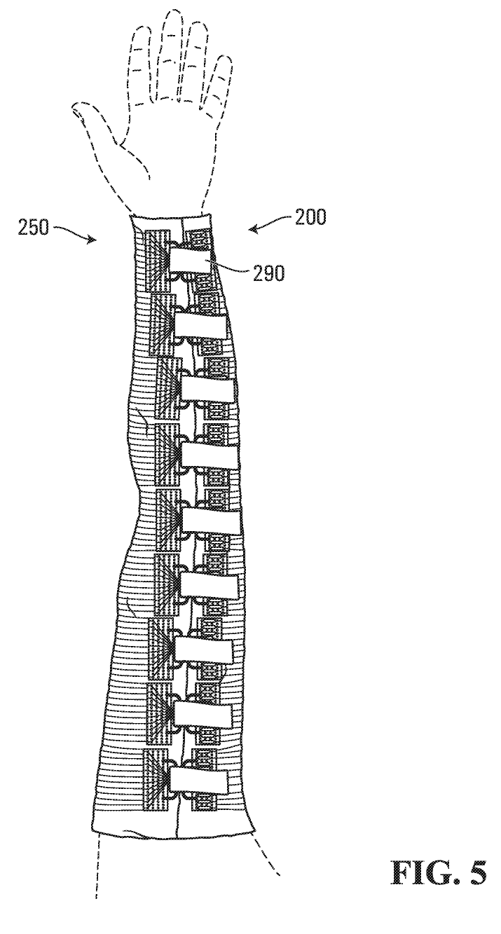

FIG. 4 is a top view of a garment 200 according to another embodiment of the disclosure in an open configuration. Like the garment 100 described with reference to FIGS. 1 to 3, the garment 200 of FIG. 4 forms a sleeve 250 in the closed position (discussed later in relation to FIG. 5).

In FIG. 4, the garment 200 is shown in an open, flat position. In the opened position, the garment 200 has a first (power) side 202 and an opposite second (ground) side 204. The garment 200 also has a proximal end 206 and a distal end 208. The first side 202 and the second side 204 slightly taper toward each other from the proximal end 206 to the distal end 208, as the size of a limb on which the garment 200 is worn will typically be thicker at a proximal end compared to a distal end.

The garment 200 includes a sheet of heat resistant cloth 210 with a plurality of electrically actuable fibers 220 sewn into the heat resistant cloth 210. The length of the fibers 220 at the proximal end are longer than the length of the fibers 220 at the distal end. For example, the length of the fibers 220 may be around 25 cm near the proximal end and around 10 cm near the distal end. The fibers 220 contract when electricity flows through them.

The sheet of cloth 210 and the fibers 220 function similar to the sheet 110 and fibers 120 of the garment 100 described above with respect to FIG. 1. As shown in FIG. 4, the fibers 220 are substantially parallel to each other and extend from near the first side 202 of the garment 200 to near the second side 204.

A control module 230 selectively actuates the electrically actuable fibers 220, for example, in the manner described earlier to apply the appropriate amount of power to each fiber 220.

The physical configuration of the electrical connections of the garment 200 will now be described. Specifically, the garment 200 comprises a plurality of electrical connections or links 300a to 300j and 302a to 302i between the electrical control module and the electrically actuable fibers. The plurality of electrical connections 300a to 300j and 302a to 302i comprises a first subset of electrical connections (power connections 300a to 300j in this example) and a second subset of electrical connections (ground connections 302a to 302i in this example). Each fiber 220 is connected to a respective combination of one of the power connections 300a to 300j and one of the ground connections 302a to 302i as will be described in more detail below. A thicker cable 301 is used in FIG. 4 to depict a bus in which the power connections travel in parallel. Similarly, a thicker cable 303 is used to show where two or more ground connections 302a to 302i travel in parallel. For example, wire bundles or cables with parallel wires may be used, which then separates into the individual wire connections.

As will be explained in more detail below, the control module 230 selects one or more of the power connections 300a to 300j and one or more of the ground connections 302a to 302i for activation, thereby selectively actuating the fibers 220. In this example embodiment, the connections 300a to 300j and 302a to 302i are wires and are connected electrically to the fibers 220 via the circuit boards 232a to 232i and 234a to 234i. The circuit boards 232a to 232i serve two primary purposes: (1) to anchor the fibers 220 so that when the fibers 220 contract they will compress (rather than pull on the wires); and (2) to provide a means for connecting the wires to the fibers. The circuit boards 234a to 234i serve the same purpose, but also include diodes 268 for providing isolation. As is clear from the more general explanation provided in relation to FIGS. 1 to 3, circuit boards may not be needed in all embodiments, but they are used specifically in the FIG. 4 embodiment for the purposes mentioned above. Note that in FIG. 4, the fibers appear as lying on top of the circuit boards 232a to 232i and 234a to 234i, and attached to the top of the circuit boards 232a to 232i and 234a to 234i (e.g. by soldering the fibers to the circuit boards 232a to 232i and 234a to 234i). It may be more beneficial to instead have the fibers travel under the circuit boards 232a to 232i and 234a to 234i and then wrap back over the top of the circuit boards and be soldered to top of the circuit boards. A similar remark applies to the other figures that show the circuit boards 232a to 232i and 234a to 234i.

The garment 210 in this example includes ninety fibers 220 each spaced about ⅕ inch apart, although more or fewer fibers and/or different spacing may be used.

The fibers 220 and the circuit boards 232a to 232i and 234a to 234i of the garment 200 are functionally divided into nine sections 251, 252, 253, 254, 255, 256, 257, 258 and 259 (which are referred to herein as first through ninth sections). Each section 251, 252, 253, 254, 255, 256, 257, 258 and 259 includes a respective group of ten of the fibers 220 and a respective pair of the circuit boards 232a to 232i and 234a to 234i. More or fewer sections (using more or fewer circuit boards) may be used, and the specific number of sections in FIG. 4 is provided by way of example. Also, more generally, there does not have to be the same number of fibers in each group.

In this embodiment, a Velcro™ strap (e.g. strap 290) is attached to each of the first series of circuit boards 232a to 232i. Each of the second series of circuit boards 234a to 234i includes a metal loop (e.g. metal loop 292). The strap 290 is sized to fit through the corresponding loop 292 for closing and fitting the garment around a limb. FIG. 5 shows the garment 200 in the closed formation to form a sleeve 250 around a user's arm. The control module 230 and the connections 300a to 300j and 302a to 302i are not shown in FIG. 5 so that the view of the Velcro™ straps is not obscured.

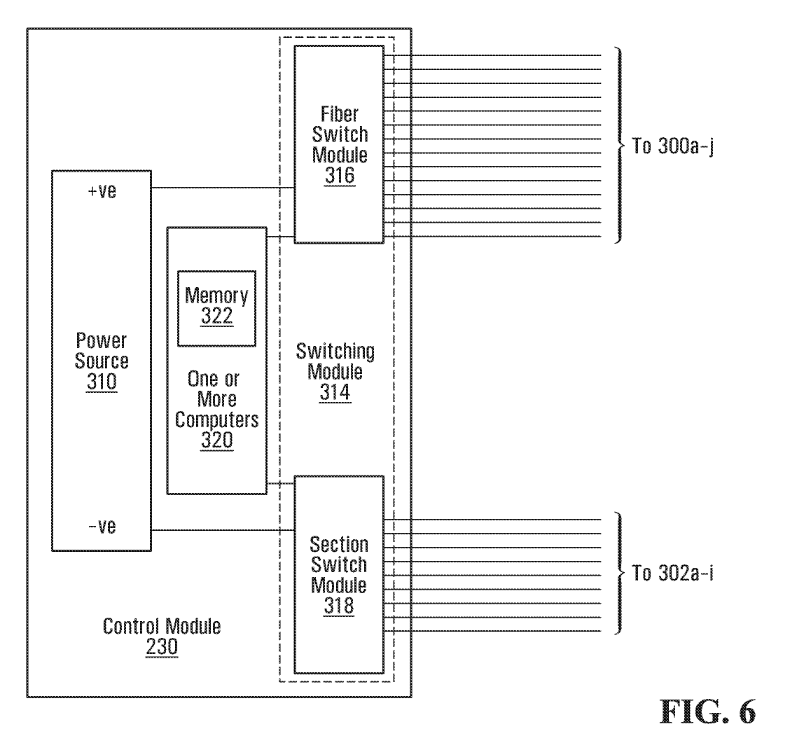

FIG. 6 illustrates the control module 230 in more detail. The control module 230 includes one or more computers 320 having a memory 322, as well as a power source 310 and a switching module 314. The power source 310 may include one or more batteries, for example. Other embodiments may utilize an external power source and/or incorporate an AC/DC converter. Other types of power sources may be used. The switching module 314 includes a fiber switch module 316 that is connected to the positive side of the power source 310 and a section switch module 318 that is connected to the negative side of the power source 310. The one or more computers 320 implement a pulse generator to generate pulses of power that are sent to the fiber switch module 316. The fiber switch module 316 selects one or more of the power wires for activation. Activation of the power connections may include closing a switch (not shown), such as a transistor switch, in the fiber switch module 316 to create an electrical path to the selected power connection. The section switch 318 selects between the ground connections 302a to 302i for activation. Activation of the ground connections 302a to 302i in this example includes closing a switch (not shown), such as a transistor switch, within the section switch module 318 module to create a path from the selected ground connection 302a to 302i to the negative side of the power source 310. However, a different switching mechanism may also be implemented by the switching module. As detailed later, the one or more computers 320 may be implemented by two Arduino™ micro-computers.

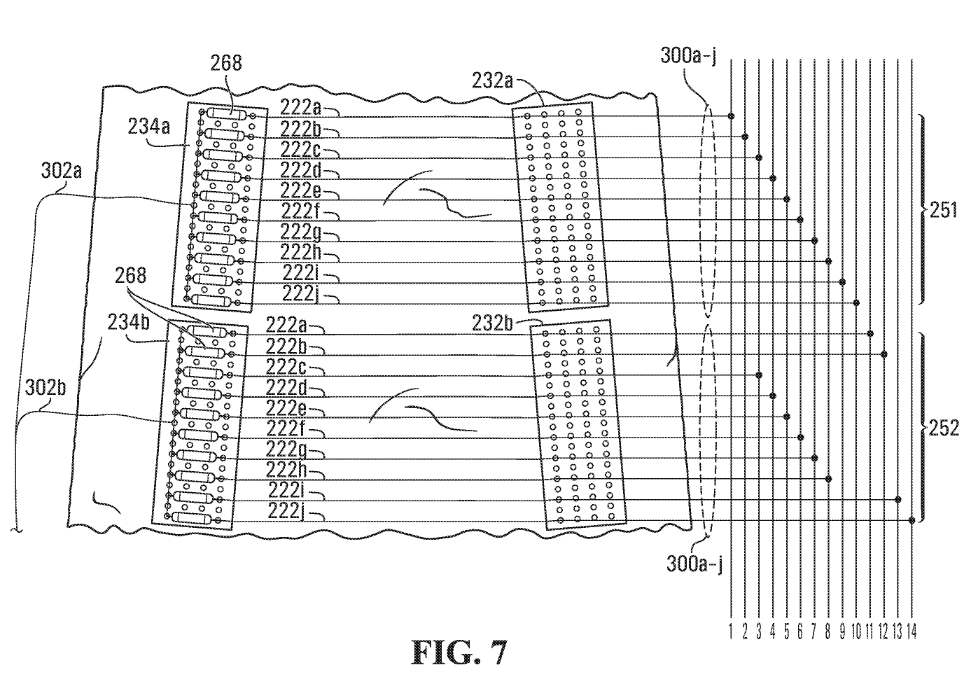

FIG. 7 is an enlarged view of the first and second sections 251 and 252 of the garment 200, with the Velcro™ straps and corresponding loops removed to better show the wires. Also, the connections on the power side are shown separate from circuit boards 232a and 232b for clarity. In implementation the electrical connections would be made on the circuit boards 232a and 232b. The power side comprises a bus of fourteen wires labelled 1 to 14. The fibers of the first section 251 are connected to wires 1 to 10 such that fiber 222a is connected to wire 1, fiber 222b is connected to wire 2, . . . , and fiber 222j is connected to wire 10. The fibers of the second section 252 are connected to wires 11, 12, 3 to 8, 13, and 14, specifically such that fiber 222a is connected to wire 11, fiber 222b is connected to wire 12, fiber 222c is connected to fiber 3 . . . , fiber 222h is connected to wire 8, fiber 222i is connected to fiber 13, and fiber 222j is connected to fiber 14. Although the other sections of the garment 200 are not shown in FIG. 7, this pattern repeats. That is, the first section 251 is connected to wires 1 to 10, the second section 252 is connected to wires 11, 12, 3 to 8, 13, and 14, the third section 253 (in FIG. 4) is connected to wires 1 to 10, the fourth section 254 (in FIG. 4) is connected to wires 11, 12, 3 to 8, 13, and 14, and so on.

As is best seen in FIG. 7, the ground side includes a plurality of the diodes 268, and a single output connection connected to each of the diodes 268. Each of the fibers 222a to 222j is connected at the ground side to a respective one of the diodes 268.

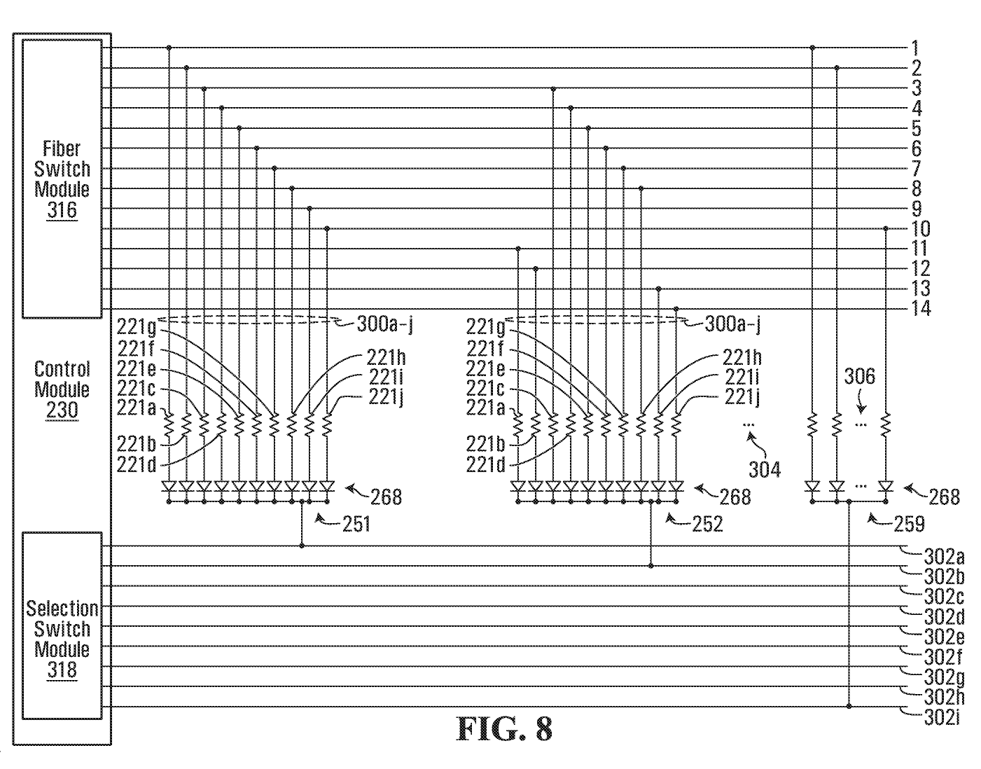

Operation of the electrical connections between the control module 230 and the fibers 220 of the garment 200 will now be explained in more detail with reference to FIG. 8. FIG. 8 is a schematic diagram of the garment 200, including the electrical control module 230, but only the fiber switch module 316 and section switch module 318 are explicitly shown in the control module 230 due to space limitations on the drawing sheet.

FIG. 8 shows the fibers, the diodes 268, the power connections 300a to 300j and the ground connections 302a to 302i. FIG. 8 also shows the first, second and ninth sections 251, 252 and 259 in more detail. Remaining sections 253, 254, 255, 256, 257 and 258 (shown in FIG. 4) are not specifically shown due to space limitations, and are replaced with the symbol “ . . . ” 304. Similarly, not all fibers for ninth section 252 is shown (due to space limitations), and some are replaced with the symbol “ . . . ” 306.

The pulse generator in the control module 230 generates electrical pulses, which travel through the switching module 316 to a selected one of the fourteen power connections 1 to 14. In order for a particular fiber to be actuated, the specific combination of the power connection (wires 1 to 14) and the ground connections 302a to 302i connected to that fiber must be activated. By way of example, if the first power connection 1 is selected, and the first ground connection 302a is selected, then the first fiber 221a in the first section 251 will receive electrical pulses and contract for as long as those electrical connections 1 and 302a are selected (and power pulses are applied). Similarly, if the second power connection 2 is selected, while the first ground connection 302a remains selected, then the second fiber 221b in the first section 251 will be actuated. Each of the individual fibers may be selected in this manner by selecting a combination of one or more power connections 1 to 14 and one or more ground connection 302a to 302i. In this example, the ninety fibers may then each be selected using a total of twenty three switch outputs (fourteen connected to the fiber switch module 316 and nine connected to the section switch module 318), as opposed to ninety switch outputs if a single switching stage/component was used.

Note that although each section contains ten fibers, there are 14 power lines. This is to facilitate the simultaneous contraction of three adjacent fibers when moving from one section to another. For example, assume the following three fibers are simultaneously contracted: fiber 221j of section 251, fiber 221a of section 252, and fiber 221b of section 252. If fibers 221a and 221b of section 252 were not connected to power wires different from the ten wires (1 to 10) that section 251 was connected to, then sending power to section 252 would also cause other wires in section 251 to power up. Since a window of three wires wide is assumed, two extra power wires on the ends of every other section are only needed. This is why the first two fibers of section 252 are connected to wires 11 and 12, and the last two fibers of section 252 are connected to wires 13 and 14. As mentioned above, the pattern is repeating, such that the odd sections (251, 253, 255, 257, and 259) are connected to power wires 1 to 10, and the even sections (252, 254, 256, and 258) are connected to power wires 11, 12, 3 to 8, 13, and 14.

Variation of this Example Embodiment

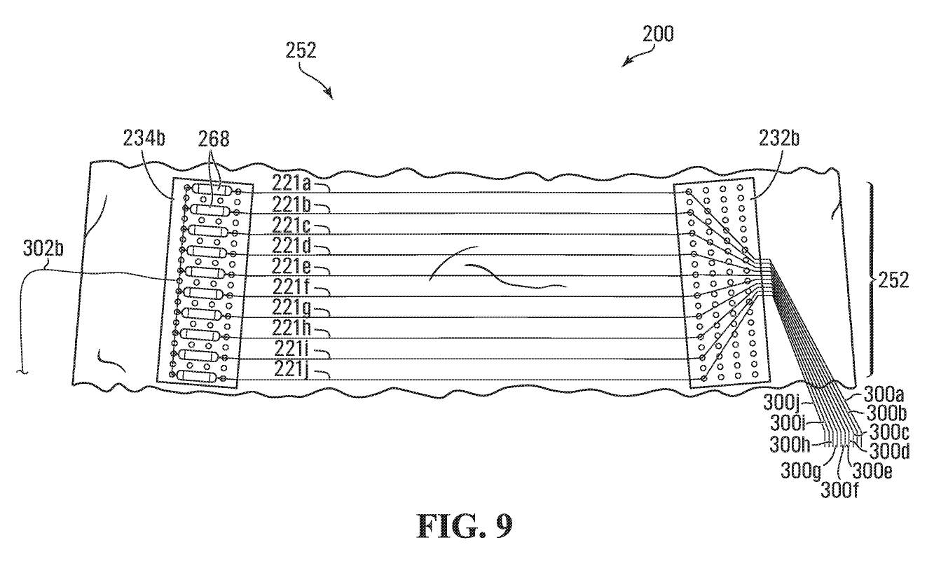

FIGS. 9 and 10 illustrate an alternative embodiment in which there are only 10 power lines. Unlike the embodiment described above, in this embodiment only one fiber is powered (actuated) at any given time, and so there is no need to have extra power wires to handle simultaneously powering (actuating) multiple wires in different sections. To actuate a particular fiber, the appropriate power and ground lines are selected. For example, with respect to FIG. 10, to actuate fiber 221b in section 251, the fiber switch module 316 selects line 300b and the section switch module 318 selects 302a. In this embodiment a travelling compression wave of multiple fibers can still be created, but this would be done by cycling between the fibers to be actuated in a round-robin fashion (e.g. provide a first power pulse to a first fiber, then provide a second power pulse to a second fiber, then provide a third power pulse to a third fiber, then provide a fourth power pulse to the first fiber, and so on).

In view of FIGS. 7 to 10, it will be appreciated that more generally the electrical connections may be as follows. A first set of wires may connect the control module to a first side of the plurality of electrically actuable fibers. A second set of wires may connect the control module to a second side of the plurality of electrically actuable fibers. The electrically actuable fibers may comprise a plurality of groups of fibers, each group including a respective set of fibers that are different from the fibers in the other groups. For each group: each fiber in that group connects to a respective different one of the first set of wires, and each fiber in that group connects to a same wire of the second set of wires.

It will be appreciated that in other variations, a single switching module may be used and may have a separate output to activate for each fiber 220, rather than using a combination of two activated connections per fiber 220. Other switching arrangements may also be used. In any case, the pattern may be selected to massage the user. For example, the fibers 220 may be activated in a sequence such that a compression wave travels up the sleeve, down the sleeve, or in both directions. The control module 230 may be programmable such that a user can program or select multiple patterns (e.g. multiple different massage sequences).

### Other Example Implementations

FIG. 11 is a schematic diagram of a garment, including a control module 730 and electrically actuable fibers 720. The FIG. 8 embodiment is implemented (i.e. 14 power wires and 9 ground wires). In this specific implementation, the control module 730 includes two micro-computers (box 732), which control (via signal 760) which of the fourteen power wires are selected, and which control (via signal 770) which of the 9 ground connections are selected. Box 734 represents a bank of switches that implement the fiber switch module and the section switch module. In this implementation, the voltage and current are monitored by the two micro-computers 732, as shown at input 735 and 736. The monitoring of the voltage and current is in the manner described earlier to determine whether or not to apply another pulse of power to the selected fiber(s). As discussed earlier, over-contraction and/or over-heating of the fibers may be prevented by applying pulses of power and monitoring to make sure that not too many or two few power pulses are provided. One way of monitoring this is to receive feedback on the voltage and current flowing. This feedback is shown via inputs 735 and 736.

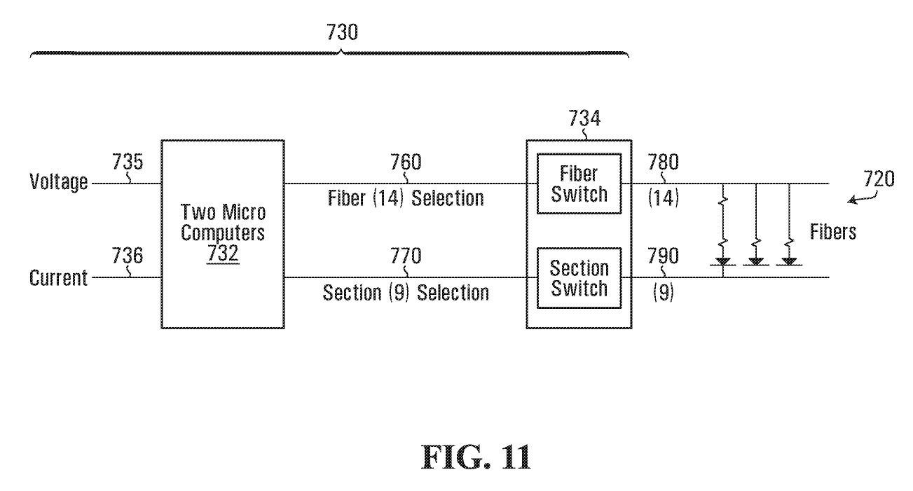

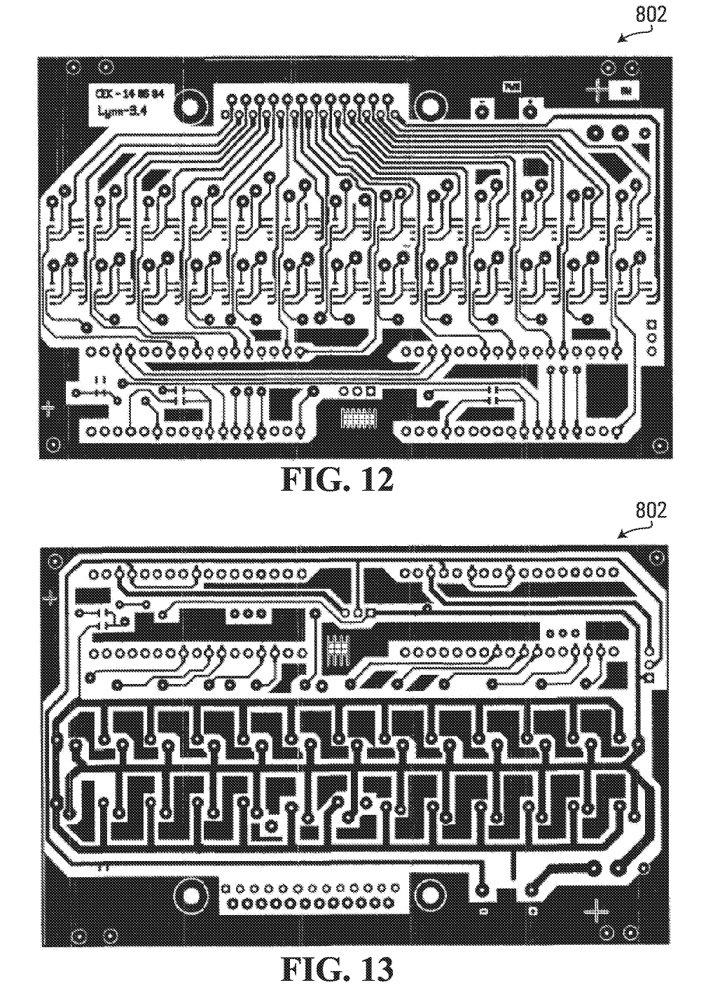

FIG. 12 and FIG. 13 are top and bottom views, respectively, of a circuit board 802 that together with other components may be used to implement the control module 730.

The two micro-computers 732 may each be an Arduino™ Micro computer equipped with both analog and digital inputs and outputs. The two computers, using Arduino development software, may be designed and programmed to operate in sync and monitor both voltage 735 and current 736, while controlling the switches that supply power to the fibers in the manner described earlier. These computers control the individual switches in a fashion organized to produce a contraction wave progressing along a limb. Two micro-computers are used in this implementation because one Arduino™ micro-computer does not have enough inputs and outputs to perform the all of the operations.

The switches in box 734 be MOSFET transistor switches. These transistor switches are controlled by the transistor-transistor logic (TTL) in the micro-computers 732. In some embodiments, there may be twenty six switches. However, in this example implementation only twenty three switches are used: fourteen switches for the power side (one for each of the 14 lines), and nine for the ground side (one for each of the nine grounds). The other three switches may be employed if the design was modified to have more sections (e.g. for a longer limb), or for a compression wave wider than 3 fibers long (which may require more power lines to deal with the overlap).

### Example General Methods

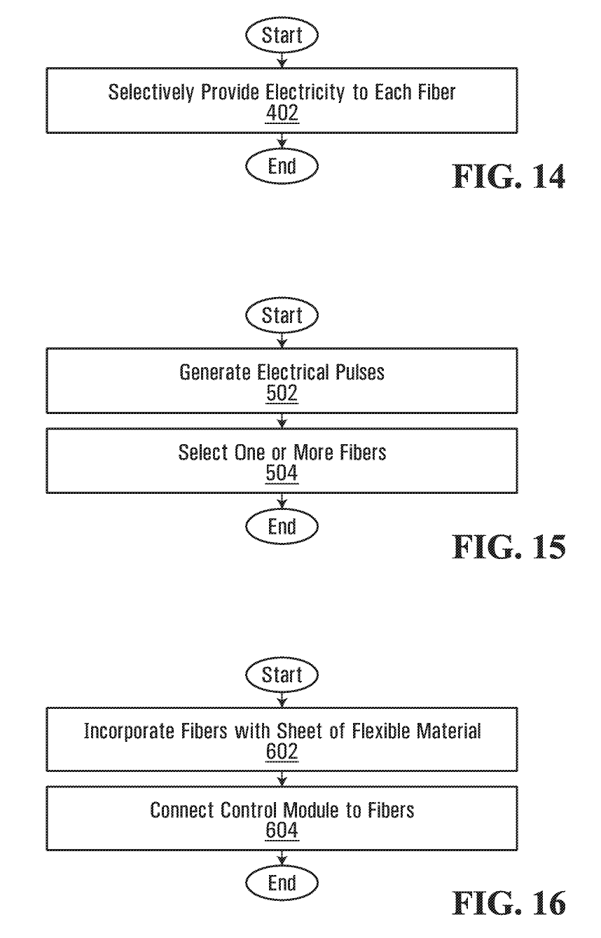

According to some embodiments, there is provided a method for controlling a massaging garment. FIG. 14 is a flowchart of an example method. In this example, the garment comprises a sheet of flexible material and a plurality of electrically actuable fibers incorporated with the flexible material in a spaced apart manner, and each electrically actuable fiber is actuable to contract when actuated with electricity. For example, the method may be performed using the garment 100 shown in FIG. 1, or the garment 200 shown in FIG. 4. At block 402, electricity is selectively provided to each electrically actuable fiber to cause each fiber to contract. Selectively providing electricity to each electrically actuable fiber may include providing electricity to the fibers of electrically actuable material in a sequential pattern to create a massaging motion, as described above. The sequential pattern may include a compression wave that travels along the limb, as described above.

FIG. 15 is a flowchart of another method of controlling the massaging garment (e.g. the garment 100 shown in FIG. 1, or the garment 200 shown in FIG. 4) according to some embodiments. At block 502, electrical pulses are generated to actuate the electrically actuable fibers. At block 504, one or more of the electrically actuable fibers is selected for actuation. In this example, selecting one or more fibers for actuation includes actuating the one or more fibers with one or more of the generated electrical pulses. However, generating electrical pulses for actuation is not required in all embodiments.

According to some embodiments, there is provided a method of producing a massaging garment as described above or below. FIG. 16 is a flowchart of an example method. At block 602, a plurality of electrically actuable fibers are incorporated with a sheet of a flexible material. Each electrically actuable fiber is actuable to contract when actuated with electricity. Incorporating the electrically actuable fibers with the sheet of flexible material may include threading the fibers into the sheet (e.g. sewing) or affixing the fibers to the sheet as described above. At block 604, a control module is electrically connected to the electrically actuable fibers to selectively provide electricity to each electrically actuable fiber to cause each fiber, when selected, to contract. The control module may be as described above or below. For example, the control module may be connected in the manner of the control module 130 shown in FIG. 1, or the control module 230 shown in FIG. 4. The fibers may be arranged to be spaced apart from each other (e.g. in parallel lines). The fibers may also have different arrangements (e.g. grid).

In some embodiments, the method shown in FIG. 16 may not include the step of connecting the control module at block 604. For example, the method may comprise: providing the sheet of flexible material; providing the plurality of electrically actuable fibers; and incorporating the electrically actuable fibers with the material. By this method, an electrically actuable material for a massaging garment (not including a control module) may be produced. As described above, the fibers may be arranged in various patterns and with various spacings. Providing the sheet of flexible material may comprise manufacturing or purchasing the sheet of flexible material. Providing the electrically actuable fibers may similarly comprise manufacturing or purchasing the electrically actuable fibers. Other methods of providing the sheet of flexible material and/or the electrically actuable fibers may also be used.

### CONCLUSION

As is clear from the above, garments are described herein to produce a massaging and/or compression motion. This may assist with the healing of an injured limb. The garments may be easier to use and/or more portable than conventional massaging garments. Thus, the portable garments described may provide injury sufferers the ability to use the device at home or elsewhere, rather than in a hospital or clinic setting, thereby possibly expanding the usefulness of such a garment.

It is to be understood that a combination of more than one of the above approaches may be implemented in some embodiments. Embodiments are not limited to any particular one or more of the approaches, methods or apparatuses disclosed herein. One skilled in the art will appreciate that variations, alterations of the embodiments described herein may be made in various implementations without departing from the scope thereof. It is therefore to be understood that within the scope of the appended claims, the disclosure may be practiced otherwise than as specifically described herein.

What has been described is merely illustrative of the application of the principles of the disclosure. Other arrangements and methods can be implemented by those skilled in the art without departing from the scope of the present disclosure.

1. A massaging garment comprising:
a sheet of flexible material;
a plurality of electrically actuable fibers incorporated with the sheet of flexible material, the electrically actuable fibers being spaced apart from each other, each electrically actuable fiber being actuable to contract when actuated with electricity; and
a control module connected to each of the electrically actuable fibers to selectively provide electricity to each electrically actuable fiber to cause each fiber, when selected, to contract.

2. The garment of claim 1, wherein the control module comprises an electric pulse generator that generates electrical pulses to actuate the electrically actuable fibers.

3. The garment of claim 1, wherein the control module is to provide a series of electrical pulses to actuate a particular fiber by:
providing one electrical pulse to the particular fiber;
determining at least one parameter after the one electrical pulse is provided; and
providing another electrical pulse to the particular fiber when the at least one parameter is less than a predetermined threshold.

4. The garment of claim 3, wherein the at least one parameter is a resistance of the particular fiber, and the predetermined threshold is a predetermined resistance value.

5. The garment of claim 4, wherein the resistance of the particular fiber is computed by the control module using voltage and current.

6. The garment of claim 4, wherein the predetermined resistance is set as a value to avoid compression and/or heating of the fiber beyond a set level.

7. The garment of claim 3 further comprising a temperature sensor on the garment, and wherein the at least one parameter is a temperature determined by the temperature sensor, and the predetermined threshold is a predetermined temperature.

8. The garment of claim 7, wherein the predetermined temperature is set to avoid heating of the fiber beyond a set level.

9. The garment of claim 1, comprising a first set of wires connecting the control module to a first side of the plurality of electrically actuable fibers, and a second set of wires connecting the control module to a second side of the plurality of electrically actuable fibers; and wherein the electrically actuable fibers comprise a plurality of groups of fibers, each group including a respective set of fibers that are different from the fibers in the other groups; wherein for each group: each fiber in that group connects to a respective different one of the first set of wires, and each fiber in that group connects to a same wire of the second set of wires.

10. The garment of claim 9, wherein the second set of wires comprises a different wire for each group.

11. The garment of claim 9, wherein the first set of wires has the same number of wires as fibers in each group.

12. The garment of claim 9, wherein the first set of wires includes a larger number of wires than number of fibers in each group, and a fiber in one group is connected to a wire in the first set of wires that is different from wires in the first set of wires that connect to fibers in an adjacent group.

13. The garment of claim 1, further comprising a first subset of electrical connections and a second subset of electrical connections, wherein:
each fiber is connected to a respective combination of one connection of the first subset of electrical connections and one connection of the second subset of connections, and
for each fiber, the control module is to activate said respective combination of one connection of the first subset of electrical connections and one connection of the second subset of electrical connections to actuate the fiber.

14. The garment of claim 13, wherein:
each of the fibers has a first end and a second end opposite to the first end;
the first subset of electrical connections is connected to the fibers at said first ends, and the second subset of electrical connections is connected to the fibers at said second ends.

15. The garment of claim 14, wherein the fibers comprise a plurality of groups of fibers, wherein each connection of the first subset of electrical connections is connected to a respective one fiber of the fibers of each group, and each connection of the second subset of electrical connections is connected to all of the fibers of a respective group.

16. The garment of claim 1, wherein the sheet of flexible material is heat resistant.

17. The garment of claim 1, wherein the control module provides electricity to the fibers of electrically actuable material in a sequential pattern to provide a massaging motion.

18. The garment of claim 17, wherein the control module is programmable to set the sequential pattern.

19. The garment of claim 17, wherein the sequential pattern comprises a wave moving along the sleeve.
